(19) United States
(12) Patent Application Publication
(10) Pub. No.: US 2009/0169684 A1
(43) Pub. Date: Jul. 2, 2009

(54) FITNESS AND EXERCISE ENHANCING TABLET CONTAINING PROTEIN ISOLATE

(76) Inventor: Andrea K. Cresta, Candia, NH (US)

Correspondence Address: Russ Weinzimmer, 614 Nashua Street, Suite 53, Milford, NH, 03055, US

(21) Appl. No.: 12/253,992

(22) Filed: Oct. 19, 2008

Related U.S. Application Data
(60) Provisional application No. 61/017,576, filed on Dec. 29, 2007.

(51) Int. Cl. A23L 1/302; A23J 1/00; A23L 1/30

(52) U.S. Cl. 426/72; 426/656; 426/74

(57) ABSTRACT

An exercise enhancing tablet, preferably a hard or chewable candy or mint, is disclosed for enhancing exercise and physical fitness when ingested before, during, and/or after exercise. The edible tablet contains a protein isolate, at least one carbohydrate, and preferably also vitamins, minerals and electrolytes. In preferred embodiments, the protein isolate is whey protein, one of the fastest metabolized sources of protein. In other embodiments, the edible tablet includes a plurality of carbohydrates, preferably dextrose, maltodextrin and fructose. The tablet can also include minerals and/or electrolytes, such as sodium, magnesium and/or potassium, and an antioxidant such as Vitamin C, as well as a flavoring, such as spearmint, peppermint, or fruit flavoring. The exercise enhancing tablets are easy to carry and ingest, even while exercising, and can be soft or hard, and can be chewed, sucked, and/or swallowed whole.

### CROSS-REFERENCES TO RELATED APPLICATIONS

This application is entitled to the benefit of U.S. Provisional Patent Application No. 61/017,576 entitled “EXERCISE ENHANCING MINT/HARD CANDY CONTAINING PROTEIN”, filed Dec. 29, 2007, herein incorporated by reference.

### FIELD OF THE INVENTION

This invention relates to health foods, and more particularly to fitness and exercise enhancing foods in tablet form.

### BACKGROUND

Exercise can be enjoyable, and provides many well known benefits for the health and well being of exercisers. However, exercise places significant demands on the body by consuming energy and stressing muscles. Proper nutritional support can be of significant help in prolonging exercise and increasing its benefits and enjoyment by providing carbohydrates for energy and/or protein for the support and repair of muscles.

There are many different kinds of health food available for the benefit of health and fitness conscious people. In particular, various convenience health and fitness foods, such as nutrition bars and energy drinks, are available for the convenience of exercisers who require extra energy and/or protein before, during, or immediately after exercise.

However, some of these convenience health and fitness foods are bulky and difficult to carry. They are also difficult to eat in the midst of continuous activity, thereby requiring that an exerciser pause, at least briefly, so as to consume the exercise food. These are significant limitations for exercisers who do not wish to carry bulky items, or to interrupt their exercise routines or their post-exercise activities, even for the time it may take to eat a nutrition bar or drink a so-called “energy drink” or “sports drink.” Nutritional drinks in particular can also be upsetting to the stomach if consumed during or immediately before or after vigorous exercise, especially if consumed suddenly and quickly.

Various exercise supporting tablets have been introduced in the prior art which are easy to carry and easy to ingest before, during, and/or after exercise. Some of these tablets contain valuable electrolytes and vitamins which can boost an exerciser's energy levels and enhance the exerciser's performance during exercise. Some tablets further include carbohydrates, and/or sweeteners for energy enhancement and/or enhanced taste. However, these prior art tablets do not provide ingredients that enhance muscle support and repair.

### SUMMARY OF THE INVENTION

An edible health and fitness food in the form of a tablet such as a candy, mint, capsule, or pill containing both carbohydrates and protein is claimed for supporting and enhancing exercise and physical fitness. The fitness food of the present invention can be consumed before, during, and/or after exercise, and can be in the form of a “hard” item that is dissolved in the mouth, a chewable item, or a tablet that is swallowed whole.

The claimed exercise enhancing tablet offers advantages over the prior art by including not only carbohydrates but also intact protein, which in preferred embodiments is whey protein isolate. The intact protein metabolizes more efficiently than free amino acids, reducing the breakdown of muscle and keeping muscle tissues stronger during exercise. The exercise enhancing tablet preferably contains a blend of carbohydrates, as well as other vitamins, minerals and electrolytes, all of which provide nutrients necessary for optimal fitness and exercise performance.

In preferred embodiments, a unique blend of carbohydrates acts to reduce the amount of simple sugars, and also increases the amount of carbohydrate uptake in the body. Dextrose and maltodextrin break down in the intestines and are efficiently transported into the circulatory system as glucose, thereby enhancing performance during aerobic exercise. Fructose is transported by its own transporter, increasing the rate of carbohydrate uptake and reducing the body's reliance on other fuel sources during exercise, thereby postponing exhaustion and fatigue and extending exercise time. In some preferred embodiments, the claimed exercise enhancing tablet includes a flavoring, so as to make the tablet more palatable.

One general aspect of the invention is an exercise enhancing tablet that includes at least one form of intact protein and at least one form of carbohydrate. Preferred embodiments also include vitamins, minerals, and/or electrolytes. In certain preferred embodiments, at least one of the forms of protein is whey protein isolate. In other preferred embodiments, a plurality of forms of carbohydrate is included, and in some of these embodiments the plurality of forms of carbohydrate includes at least one of dextrose, maltodextrin, and fructose. In various preferred embodiments the tablet further includes sodium, magnesium, potassium, and/or Vitamin C.

In preferred embodiments, the tablet is one of the following:

a hard tablet edible by dissolving in a mouth;

a soft tablet edible by chewing; and

a tablet edible by swallowing the tablet whole.

In certain preferred embodiments the exercise enhancing tablet is a candy or a mint, and in some preferred embodiments the tablet includes at least one flavoring, which can be mint or fruit flavoring, and can taste like spearmint or peppermint.

In preferred embodiments the carbohydrate and intact protein are included in the tablet in a ratio of between 1.6 to 1 and 2.4 to 1 respectively by weight. And in some preferred embodiments the carbohydrate and intact protein are included in the tablet in a ratio of substantially 2 to 1 respectively by weight.

Another general aspect of the invention is an exercise enhancing tablet, each tablet including ingredients in amounts by weight as follows:

Dextrose 1.2 to 1.4 grams;

Maltodextrin 1.2 to 1.4 grams;

Fructose 1.2 to 1.4 grams; and

Whey Protein 1.8 to 2.1 grams.

In preferred embodiments of this general aspect, the tablet further includes ingredients by weight as follows:

Sodium 120 to 160 milligrams;

Magnesium 55 to 65 milligrams;

Potassium 55 to 65 milligrams; and

Vitamin C 25 to 32 milligrams.

In various preferred embodiments, the exercise enhancing tablet is a hard candy or a mint. And in some preferred embodiments the tablet includes at least one flavoring. In some of these embodiments the flavoring tastes like one of mint and fruit, and in other of these preferred embodiments, the flavoring tastes like one of spearmint and peppermint.

### DETAILED DESCRIPTION OF PREFERRED EMBODIMENTS

The present invention is an exercise enhancing tablet that can be dissolved in the mouth, chewed, or swallowed, so as to provide nutritional support to an exerciser before, during, and/or after exercise. The tablet can be in the form of a typical, medicinal “pill” or capsule, but is preferably in the form of a hard candy or chewable mint.

The exercise enhancing tablet provides nutritional support by including at least one carbohydrate as well as a complete protein, thereby supplying energy for use during exercise and protein for support and repair of muscles.

Preferred formulation is presented in Table 1 and Table 2 below:

TABLE 1
Ingredients Included in a Preferred Embodiment

| Ingredient | Quantity Range | Units |
|---|---|---|
| Dextrose | 1.2-1.4 | grams |
| Maltodextrin | 1.2-1.4 | grams |
| Fructose | 1.2-1.4 | grams |
| Whey Protein | 1.8-2.1 | grams |

TABLE 2
Electrolytes and Vitamins Included in a Preferred Embodiment
(in addition to carbohydrates and protein)

| Ingredient | Quantity Range | Units |
|---|---|---|
| Sodium | 120-160 | milligrams |
| Magnesium | 55-65 | milligrams |
| Potassium | 55-65 | milligrams |
| Vitamin C | 25-32 | milligrams |

It can be seen from Table 1 that the ratio of carbohydrates to protein (by weight) in a certain preferred embodiment is approximately 2 to 1. In preferred embodiments such as the one presented in Table 1, whey protein isolate is included in the tablets, since whey protein isolate has been shown to be a rapidly metabolized protein source, thereby making it ideal for providing muscle tissue with amino acids in a timely manner. It can also be seen from Table 2 that electrolytes and Vitamin C are included in the formulation of some preferred embodiments, so as to further boost an exerciser's energy levels and enhance the exerciser's performance during exercise.

Similar preferred embodiments include flavoring, such as fruit flavor, peppermint, or spearmint, so as to make the mints more enjoyable to consume. In fact, some embodiments include sufficient flavoring to be eaten purely for enjoyment.

Other modifications and implementations will occur to those skilled in the art without departing from the spirit and the scope of the invention as claimed. Accordingly, the above description is not intended to limit the invention except as indicated in the following claims.

What is claimed is:

1. An exercise enhancing tablet, comprising:
at least one form of intact protein; and
at least one form of carbohydrate.

2. The exercise enhancing tablet of claim 1, further comprising at least one of vitamins, minerals, and electrolytes.

3. The exercise enhancing tablet of claim 1, wherein one of the forms of protein is whey protein isolate.

4. The exercise enhancing tablet of claim 1, wherein a plurality of forms of carbohydrate is included

5. The exercise enhancing tablet of claim 4, wherein the plurality of forms of carbohydrate includes at least one of dextrose, maltodextrin, and fructose.

6. The exercise enhancing tablet of claim 1, further comprising at least one of sodium, magnesium, potassium, and Vitamin C.

7. The exercise enhancing tablet of claim 1, wherein the tablet is one of:
a hard tablet edible by dissolving in a mouth;
a soft tablet edible by chewing; and
a tablet edible by swallowing the tablet whole.

8. The exercise enhancing tablet of claim 1, wherein the tablet is one of a candy and a mint.

9. The exercise enhancing tablet of claim 1, wherein the tablet includes at least one flavoring.

10. The exercise enhancing table of claim 9, wherein the flavoring tastes like one of mint and fruit.

11. The exercise enhancing tablet of claim 9, wherein the flavoring tastes like one of spearmint and peppermint.

12. The exercise enhancing tablet of claim 1, wherein the carbohydrate and intact protein are included in the tablet in a ratio of between 1.6 to 1 and 2.4 to 1 respectively by weight.

13. The exercise enhancing tablet of claim 1, wherein the carbohydrate and intact protein are included in the tablet in a ratio of substantially 2 to 1 respectively by weight.

14. An exercise enhancing tablet comprising ingredients in amounts by weight as follows:
Dextrose 1.2 to 1.4 grams;
Maltodextrin 1.2 to 1.4 grams;
Fructose 1.2 to 1.4 grams; and
Whey Protein 1.8 to 2.1 grams.

15. The exercise enhancing tablet of claim 14, further comprising ingredients by weight as follows:
Sodium 120 to 160 milligrams;
Magnesium 55 to 65 milligrams;
Potassium 55 to 65 milligrams; and
Vitamin C 25 to 32 milligrams.

16. The exercise enhancing tablet of claim 14, wherein the tablet is one of a hard candy and a mint.

17. The exercise enhancing tablet of claim 14, wherein the tablet includes at least one flavoring.

18. The exercise enhancing table of claim 17, wherein the flavoring tastes like one of mint and fruit.

19. The exercise enhancing tablet of claim 17, wherein the flavoring tastes like one of spearmint and peppermint.
